(19) United States
(12) Patent Application Publication
(10) Pub. No.: US 2013/0229348 A1
(43) Pub. Date: Sep. 5, 2013

(54) DRIVING METHOD OF VIRTUAL MOUSE

(71) Applicant: Kil Jae Lee, Seongnam-si Gyeonggi-Do (KR)

(72) Inventor: Kil Jae Lee, Seongnam-si Gyeonggi-Do (KR)

(73) Assignee: MACRON CO., LTD., Seongnam-si Gyeonggi-Do (KR)

(21) Appl. No.: 13/883,441

(22) PCT Filed: Oct. 31, 2011
(86) PCT No.: PCT/KR11/08210

§ 371 Date: May 3, 2013

(30) Foreign Application Priority Data
Nov. 4, 2010 (KR) 10-2010-0109198

(51) Int. Cl. G06F 3/01

(52) U.S. Cl. CPC G06F 3/017
USPC 345/163

(57) ABSTRACT

Provided is a new type of virtual mouse driving method which is independent from individual skin color and capable of being implemented in general environments having a certain degree of disturbance. The virtual mouse driving method according to the invention in which a method of driving the virtual mouse is controlled by a change of hand shape includes an input step of receiving a plurality of images captured by an imaging camera at mutually different time points, a difference image extracting step of extracting a difference image among a plurality of images, and a virtual mouse driving step based on the extracted difference image.

### TECHNICAL FIELD

The present invention relates to a virtual mouse driving method, and more particularly, to a virtual mouse driving method using hand image information acquired from an imaging camera.

### BACKGROUND ART

According to technical evolution of a display device into a smart system, interaction with the display device is becoming more important. Similarly to a computer, a smart display device needs to have a command input based on a position on the screen of the display device. A mouse, as an input device, is the most common method having such command input. Further, in latest popular smartphones, it is possible to command input based on the position of the screen using a touchscreen.

In an existing input method using the touch screen, in order to make position-based commands, there are many limitations since the command is transmitted through contact with the display device. That is, it is possible only when the display device is within a hand-contact distance. Furthermore, the mouse is not a smart input device in terms of its physical size and shape.

In recent years, input devices in which commands can be transmitted to the display device in a non-contact manner are being released, for example, a virtual mouse. In particular, commanding methods with gesture recognition using a 3D camera are under development in the gaming field. In a method using a 3D camera, an object image performing gestures can be easily separated from background images in the input image, but the method requires high-priced and complex input devices. Furthermore, due to a low resolution, the method is very inconvenient since the command input requires large gestures from a user.

Prior art related to the virtual mouse is disclosed in Korean Unexamined Patent Application Publication No. 2007-0030398, Korea Patent No. 0687737, and Korean Unexamined Patent Application Publication No. 2008-0050218. These patents disclose methods in which a recognized gesture of one hand or both hands in the image input from the camera has a function of the virtual mouse. In these recognition methods, since a specific command is generally recognized by stopped shape of a finger, in order to recognize the stopped shape of the finger, a process of separating the finger from the background images is necessary. Therefore, a process of separating a hand area from the background images using color information of the hand is essential. In this case, due to differences in individual hand colors, when an absolute value of hand color is used, a sophisticated model registration process and a recognition process are necessary. When a background is similar to hand color, or background brightness is not constant, it is difficult to separate the hand. As a result, it is difficult to implement in general environments having disturbance as opposed to a well-designed laboratory environment.

Therefore, development of a new type of virtual mouse driving method which is independent from individual skin color and capable of being implemented in general environments having disturbance is needed.

### DISCLOSURE

### Technical Problem

The present invention has been made in view of the above-mentioned problems and an object of the invention is to provide a new type of virtual mouse driving method which is independent from individual skin color and capable of being implemented in general environments having a certain degree of disturbance.

### Technical Solution

In order to achieve the above-described purposes, the virtual mouse driving method according to the invention in which a method of driving the virtual mouse is controlled by a change of hand shape, which includes an input step of receiving a plurality of images captured by an imaging camera at mutually different time points, a difference image extracting step of extracting the difference image among the plurality of images, and a virtual mouse driving step based on the extracted difference image.

According to the invention, it is preferable that motion information on contacting and releasing between thumb and index finger of a user be extracted from the difference image and the motion information be used as a click signal of the virtual mouse.

In addition, according to the invention, it is preferable that difference images be consecutively extracted from the plurality of images and the motion information be extracted by analyzing a position change of the thumb or the index finger in the consecutive difference images.

Further, according to the invention, it is preferable that a recognized number of contacts and releases between the thumb and the index finger be used as a specific command signal.

### Advantageous Effects

With such a configuration, it is possible to implement a virtual mouse system which is independent from individual skin color and is accurately driven in general environments having a certain degree of disturbance.

### DESCRIPTION OF DRAWINGS

FIG. 1 is a schematic diagram illustrating a configuration of a device for implementing a virtual mouse driving method according to an embodiment of the invention.

FIG. 2 is a schematic flow diagram for explaining a process of a hand gesture recognition unit illustrated in FIG. 1.

FIG. 3 is a diagram for explaining a difference image.

FIGS. 4 and 5 are diagrams illustrating consecutive images and difference images thereof.

### MODES OF THE INVENTION

Hereinafter, a virtual mouse driving method according to exemplary embodiments of the invention will be described in detail with reference to the accompanying drawings.

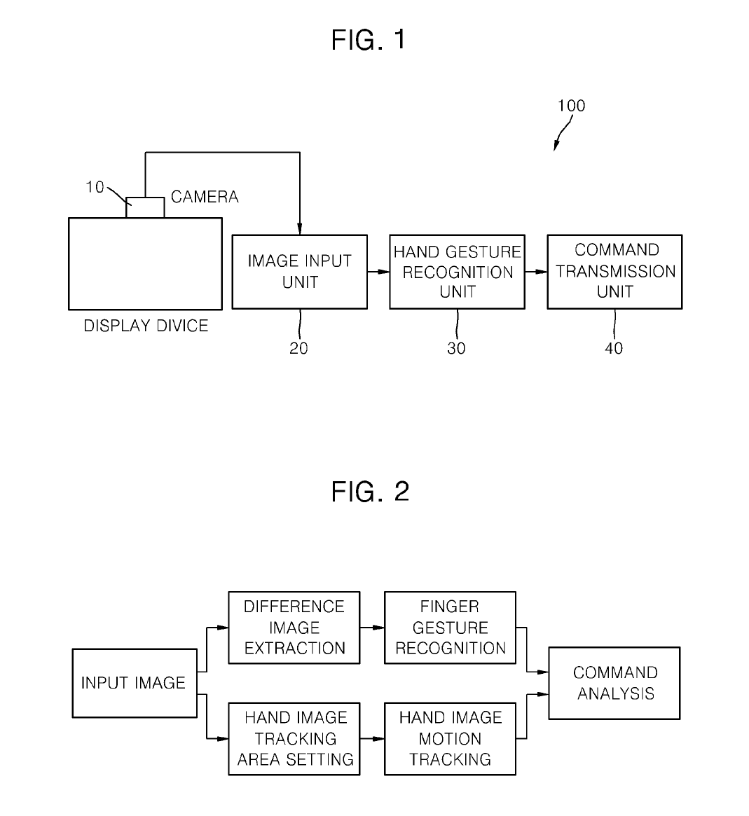

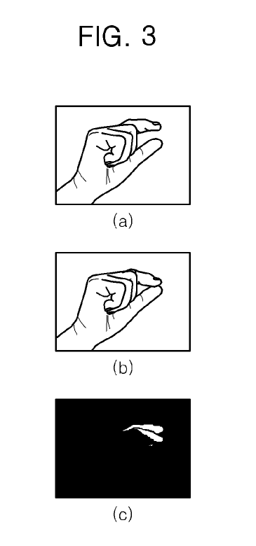

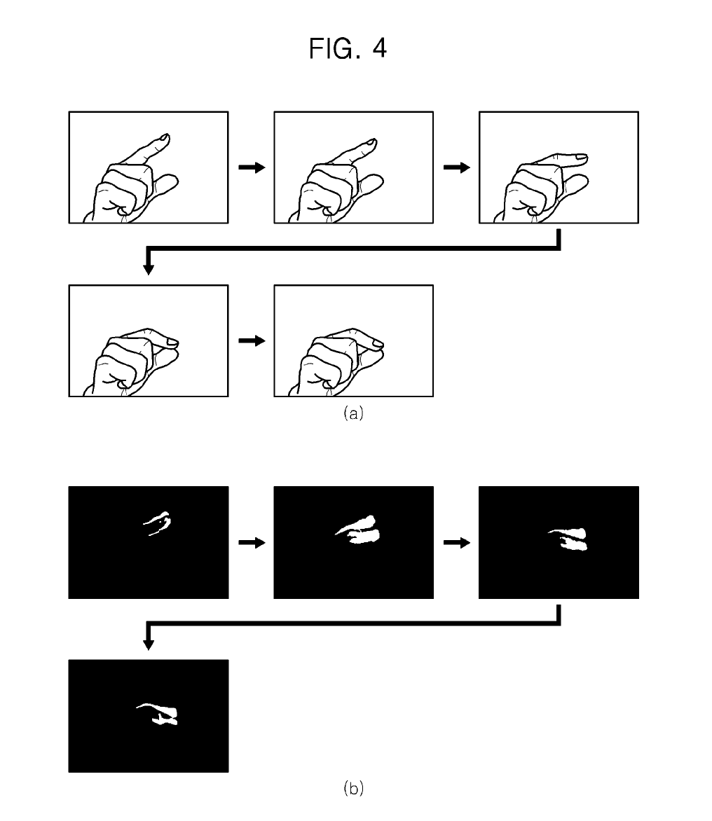

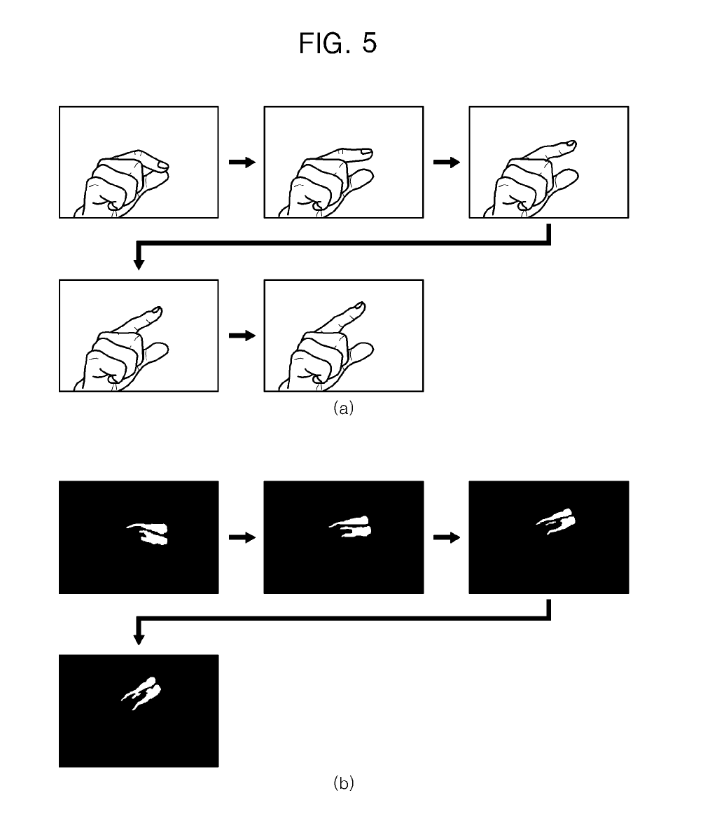

FIG. 1 is a schematic diagram illustrating a configuration of a device for implementing a virtual mouse driving method according to an embodiment of the invention. FIG. 2 is a schematic flow diagram for explaining a process of a hand gesture recognition unit illustrated in FIG. 1. FIG. 3 is a diagram for explaining a difference image. FIGS. 4 and 5 are diagrams illustrating consecutive images and corresponding difference images thereof.

With reference to FIGS. 1 to 5, the virtual mouse driving method according to the embodiment is implemented in the virtual mouse system. The virtual mouse system 100 includes a camera 10, an image input unit 20, a hand gesture recognition unit 30, and a command transmission unit 40.

The camera 10 captures images input from a lens by an imaging device such as a CCD or CMOS and outputs the images. The camera may be implemented by, for example, a digital camera, and captures user hand images and transmits the images to the image input unit.

The image input unit 20 receives images captured by the camera in real-time. The hand gesture recognition unit 30 extracts the difference image from the images input in the image input unit. The difference image is one of image processing methods for separating an object from a 2D image and is an image displaying only a changed portion between two images. Specifically, comparing FIGS. 3A and 3B, only a position of the index finger is changed, and the difference image between FIGS. 3A and 3B is represented as FIG. 3C. Then, motion information on contact and release between thumb and index finger of the user is extracted and this motion information is transmitted to the command transmission unit.

In this case, as illustrated in FIG. 3, when only one difference image acquired from two images is used, it is difficult to identify whether the thumb and the index finger are contacted after releasing or are released after contacting. Therefore, four consecutive difference images as illustrated in FIG. 4B are secured from a plurality of screens (images), for example, hand shape images captured at five time points as illustrated in FIG. 4A, and then, by comparing the position change of the index finger in this difference image, it is possible to identify whether the thumb and the index finger are contacting or releasing. In FIG. 4B, a position of the index finger is changed to a lower side (thumb side). In this case, it is determined that the thumb and the index finger are contacting after releasing. On the other hand, as illustrated in FIG. 5B, since a position of the index finger is changed to an upper side, it is determined that the thumb and the index finger are releasing after contacting.

In this way, with a plurality of consecutive difference images, it is possible to acquire more accurate motion information on the thumb and the index finger. Moreover, since a direction of a finger motion is determined by the plurality of difference images, some external disturbance may be excluded, and therefore accurate motion information may be acquired (disturbance may be excluded since it has no directivity as the finger does, and disturbance exclusion may be possible based on analysis of forms, for example, a size, an angle, and a shape of the difference image)

Meanwhile, different types of difference images based on finger gestures may be secured but the embodiment uses images in which the thumb and the index finger are releasing after contacting. The reasons are given below. First, since a gesture in which the thumb and the index finger contact each other hardly occurs in general situation, it can be easily distinguished from other general gestures and has a low recognition error. Further, it is appropriate for image processing since a definitive difference image is generated. In addition, due to the simplicity of the gesture, it is not tiring or difficult even when the user performs repeated operations consecutively for a long time.

Furthermore, the hand gesture recognition unit 30 keeps track of all or a part of hand image in order to implement a mouse movement operation. In a general image tracking method, all or a part of a hand image is set to a tracking area, a moveable space is set, a position of a hand movement is calculated when a position having the highest similarity is found, and these processes are repeated, and thus a movement signal for a virtual mouse movement operation is implemented. Such a virtual mouse movement method is a well-known method, and the description thereof will not be repeated.

The command transmission unit 40 outputs a driving signal corresponding to information, specifically, a hand motion (mouse position movement) and motion information of a finger (mouse click), output from the hand gesture recognition unit, thereby driving the virtual mouse. For example, when the number of gestures in which fingers are released after contacting is one, a click signal for clicking the mouse is output.

When the number of gestures in which fingers are released after contacting is two, it is used as a signal indicating an initial starting point of the input device. In particular, it is difficult to define the initial starting point for implementing a gesture-recognition based input device. In an existing method, in order to find the initial starting point, a display area is previously set on the screen, and the initial starting point is recognized when the hand is matched in this display area. However, in the above-described method, a sophisticated gesture in which the user's hand is to be positioned in the display area on the screen is necessary, which results in a lot of time to start the system. However, according to the embodiment, it is possible to quickly recognize the initial starting point based on when the gesture in which the thumb and the index finger contact and release is performed twice.

In addition, in order to distinguish between a drag gesture of moving while the mouse is clicked and a moving gesture without clicking, it is recognized whether the thumb and the index finger are moving in contact or moving in non-contact, and the driving signal is output accordingly. That is, the drag gesture can be performed such that a moving state while a button of the virtual mouse is clicked is recognized as a gesture of moving while the fingers are in contact, and a moving state without clicking a button of the virtual mouse is recognized as a moving gesture while the fingers are released.

Moreover, in order to effectively control the display device, gestures in addition to a general mouse operation may be necessary. For example, volume control or return to a main menu screen may be necessary. In this case, it is possible to define a variety of commands based on the number of click gestures (gestures in which fingers are released after contacting). For example, it is possible to return to the main menu screen when the click gesture is performed three times.

As described above, the virtual mouse driving method according to the embodiment basically extracts motion information on the hand according to the difference image. Since it is unaffected by skin color, model registration about users is unnecessary and there are no recognition error problems due to race. In addition, it is unaffected by color of the surrounding environment or backlight brightness. Therefore, the virtual mouse system can be effectively implemented in general environments having a certain degree of disturbance.

By using the motion of the thumb and the index finger, it is not tiring or difficult even when the user performs repeated operations consecutively. Since the motion can be easily distinguished from other general gestures, a possibility of recognition error is low.

Exemplary embodiments of the invention have been described above, but the invention is not limited to the above-described embodiments. Various modifications and changes of the invention can be made by those skilled in the art without departing from the scope and spirit of the invention but all of the corresponding modifications fall within the scope of the invention defined by the appended claims.

1. A method of driving a virtual mouse in which the virtual mouse is controlled by a change of hand shape, the method including:
inputting a plurality of images captured by a camera at mutually different time points;
extracting a difference image among the plurality of images; and
driving the virtual mouse based on the extracted difference image.

2. The method of driving a virtual mouse of claim 1,
wherein motion information in which a thumb and a part of another finger of a user contact and release is extracted from the difference image, and the motion information is used as a click signal of the virtual mouse.

3. The method of driving a virtual mouse of claim 2,
wherein the motion information is information in which the thumb and index finger contact and release.

4. The method of driving a virtual mouse of claim 3,
wherein the difference image is consecutively extracted from the plurality of images, and the motion information is extracted by analyzing a position change of the thumb or the index finger in the consecutive difference images.

5. The method of driving a virtual mouse of claim 3,
wherein a recognized number of contacts and releases between the thumb and the index finger is used as a specific command signal.

6. The method of driving a virtual mouse of claim 3,
wherein a hand position movement of the user is calculated and the hand position movement is used as a movement signal of the virtual mouse such that movement while the thumb and the index finger are in contact is used as a moving signal while a button of the virtual mouse is clicked, and movement while the thumb and the index finger are not in contact is used as a moving signal without clicking a button of the virtual mouse.
